(19) United States
(12) Patent Application Publication
(10) Pub. No.: US 2005/0015381 A1
(43) Pub. Date: Jan. 20, 2005

(54) Database management system

(76) Inventors: Paul Ian Clifford, West Dulwich (GB); Rory Anthony Bhandari, Loughborough (GB)

Correspondence Address: FISH & RICHARDSON PC, 225 FRANKLIN ST, BOSTON, MA, 02110, US

(21) Appl. No.: 10/488,592

(22) PCT Filed: Sep. 4, 2001
(86) PCT No.: PCT/GB01/03943

(51) Int. Cl. G06F 7/00

(52) U.S. Cl. 707/100

(57) ABSTRACT

A database system configures a storage model in accordance with a hierarchical tree-like structure to enable fast and comprehensive data extraction functions. A plurality of entities, attributes and entity occurrences are each assigned a unique, multi-character expression. The expression has a predetermined hierarchical structure which defines the relationship between each entity, attribute and entity occurrence with every other entity, attribute and entity occurrence. The expressions are stored in an expression set table linking each element of each expression with a natural language phrase or data definition. Events are recorded in an entity history table each event having an associated expression. Data is extracted from the database according to a multi-character query expression comprising characters that are deterministic to the query and characters that are non-deterministic to the query. Data extracted from the database is also filtered according to a plurality of multi-character profile expressions each comprising characters that are deterministic and characters that are non-deterministic and which together define filtration criteria.

The present invention relates to database systems, and in particular to a database system which configures a data model in accordance with a hierarchical tree-like structure which enables fast and comprehensive data extraction, querying and output display functions.

There are presently very many ways of constructing and maintaining database structures on computer systems. As is well known, the relational database is widely used. In a relational database, every entity in a data model has a number of attributes which may be accorded values selected either from discrete sets of values, or from within ranges of continuously variable values. All entity occurrences having the same attribute types are stored in a relation table, with each entity occurrence occupying a row, or tuple of the table having a field or element corresponding to each attribute. Each field of the row contains an alphanumeric value for the relevant attribute value. Separate tables are provided for different entities each having a different set of attributes.

The data model, or representation of the relationships between the different entities, is provided both implicitly by the incidence of common attributes between the various relation tables, and also by imposing conditions on various attributes such as their identification as key fields.

In extracting data from the database, a query is formulated, in suitable programming language, which instructs the data processing system to scan selected attribute columns of specified tables for adherence to certain conditions, and to output, usually into an output table, the data in preselected attribute columns for each tuple or row of the scanned table or tables. The output table can then be browsed by the user on screen, or printed out.

A number of disadvantages present themselves with this technique. Queries must be formulated using particular query languages which must be learnt by the users. Although these are commonly interfaced with a “natural language” interface making their use easier for the non-expert user, certain rules and protocols must be understood.

A further disadvantage is that the queries are quite specific, and do not generally permit what we shall call “progressive browsing”: that is to say, once a query has been formulated, the resulting output table is produced, and the information contained therein is fixed and limited to the scope of the original query. Further scanning of the output table is possible by formulating a further query to reduce the size of the output by imposing additional limitations on the ranges of values that an attribute may take, for example, but generally, for browsing through the database, a new query must be formulated each time to scan the appropriate parts of the database. In general (except where the selected attribute is the index field), in re-scanning the output table(s) to answer a “sub-query”, the whole of the table or tables must be searched for adherence to the new selection criteria.

In processing a query, it is normally necessary to perform quite complex manipulations on the various tables involved in the query, which include joining or merging operations, and the temporary creation of intermediate tables to be used as the operands for subsequent parts of the query. Such operations naturally involve considerable processing power and time to carry out.

A further disadvantage is that the relational database must generally be designed and constructed to conform to the data model representing the organisation of interest. This is typically performed by a skilled analyst, and is not particularly flexible once set up.

Relational databases also provide for the generation of user-specific views of the extracted data. For example, classes of different users may be permitted to view or access contents of only certain tables, or certain portions of tables in the database. This is typically implemented by providing an access control mechanism that prevents access to, or display of results from, predetermined tables, tuples of tables, and/or columns of tables according to the user identity implementing the query. This may be effected by an access specification that is used by the system when generating the query output to determine which tables may be accessed by a particular user or class of user.

An innovative database management system that offers considerable benefits over the relational database systems referred to above has been described in GB 2293667B, relevant parts of which are reproduced in this specification.

The present invention is particularly concerned with techniques for improving the functionality of the database system described in GB '667 particularly in respect of user-specific functions and providing enhanced output options.

According to one aspect, the invention provides a method of operating a database system comprising the steps of:
assigning to each of a plurality of entities, attributes and entity occurrences, a unique, multi-character expression, the expression having a predetermined hierarchical structure which defines the relationship between each entity, attribute and entity occurrence;
storing said expressions in an expression set table linking each element of each expression with a data definition relating the expression to a hierarchical level and a position in a data model;
recording events in an entity history table, each event having associated therewith a relevant expression from the expression set table;
extracting records from the database according to a multi-character query expression comprising characters which are deterministic to the query and characters which are not deterministic to the query;
filtering the extracted records according to a plurality of multi-character profile expressions each comprising characters that are deterministic and characters that are non-deterministic and which together define filtration criteria;
outputting only extracted records that meet the filtration criteria and match the query expression.

According to another aspect, the present invention provides a method of operating a database system comprising the steps of:
assigning to each of a plurality of entities, attributes and entity occurrences, a unique, multi-character expression, the expression having a predetermined hierarchical structure which defines the relationship between each entity, attribute and entity occurrence;
storing said expressions in an expression set table linking each element of each expression with a data definition relating the expression to a hierarchical level and a position in a data model;
recording events in an entity history table, each event having associated therewith a relevant expression from the expression set table;
extracting records from the database according to a Boolean combination of (i) a multi-character query expression comprising characters which are deterministic to the query and characters which are not deterministic to the query and (ii) a plurality of multi-character profile expressions each profile expression comprising characters that are deterministic to predetermined filtration criteria and characters that are non-deterministic to predetermined filtration criteria, by selecting records in which every deterministic character of the Boolean combination matches a corresponding deterministic character in said expressions in the database; and
outputting said extracted records.

According to another aspect, the present invention provides database apparatus comprising:
means for storing, for each of a plurality of entities, attributes and entity occurrences a unique, multi-character expression, the expression having a predetermined hierarchical structure which defines the relationship between each entity, attribute and entity occurrence;
means for storing said expressions in an expression set table linking each element of each expression with a data definition relating the expression to a hierarchical level and a position in a data model;
means for storing, in an entity history table, a plurality of recorded events, each event having associated therewith a relevant expression from the expression set table;
a query processor for extracting records from the database according to a multi-character query expression comprising characters that are deterministic to the query and characters that are not deterministic to the query;
a profile processor for filtering the extracted records according to a plurality of multi-character profile expressions each comprising characters that are deterministic and characters that are non-deterministic and which together define filtration criteria; and
output means for generating an output of all extracted records that match the filtration criteria.

According to another aspect, the present invention provides a method of operating a database system comprising the steps of:
assigning to each of a plurality of entities, attributes and entity occurrences, a unique, multi-character expression, the expression having a predetermined hierarchical structure which defines the relationship between each entity, attribute and entity occurrence;
storing said expressions in an expression set table linking each element of each expression with a data definition relating the expression to a hierarchical level and a position in a data model;
recording events in an entity history table, each event having an event time and a relevant expression from the expression set table associated therewith; and
extracting records from the entity history table according to a multi-character query expression comprising characters that are deterministic to the query and characters that are not deterministic to the query, and according to a predetermined time window function.

The present invention will now be described by way of example, and with reference to the accompanying drawings in which:

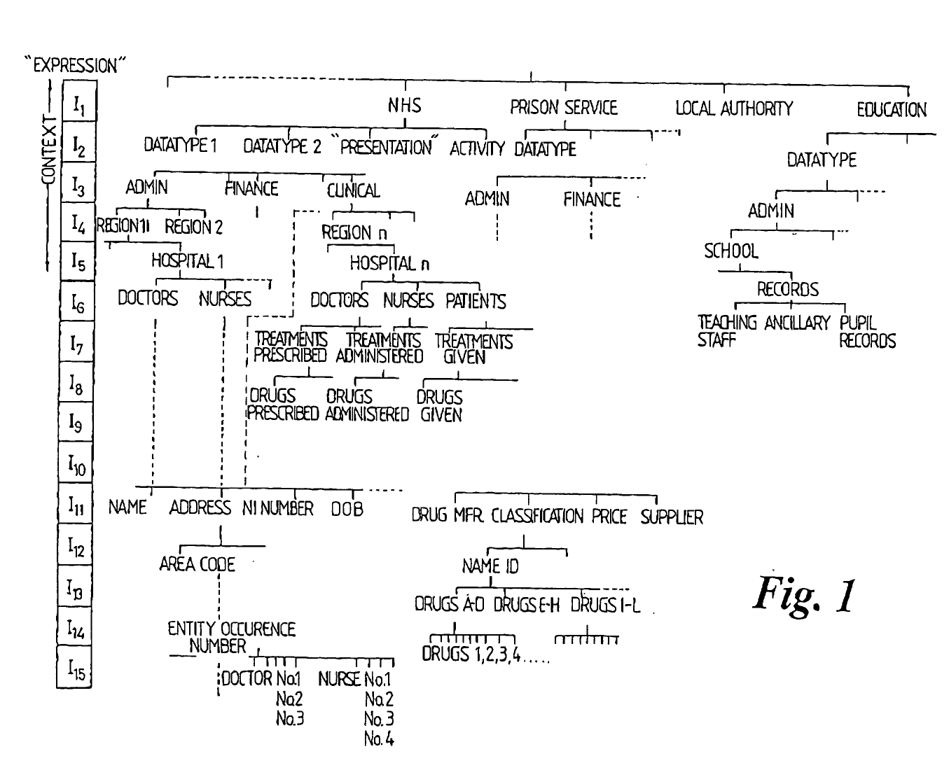

FIG. 1 shows an exemplary data model useful in describing the present invention;

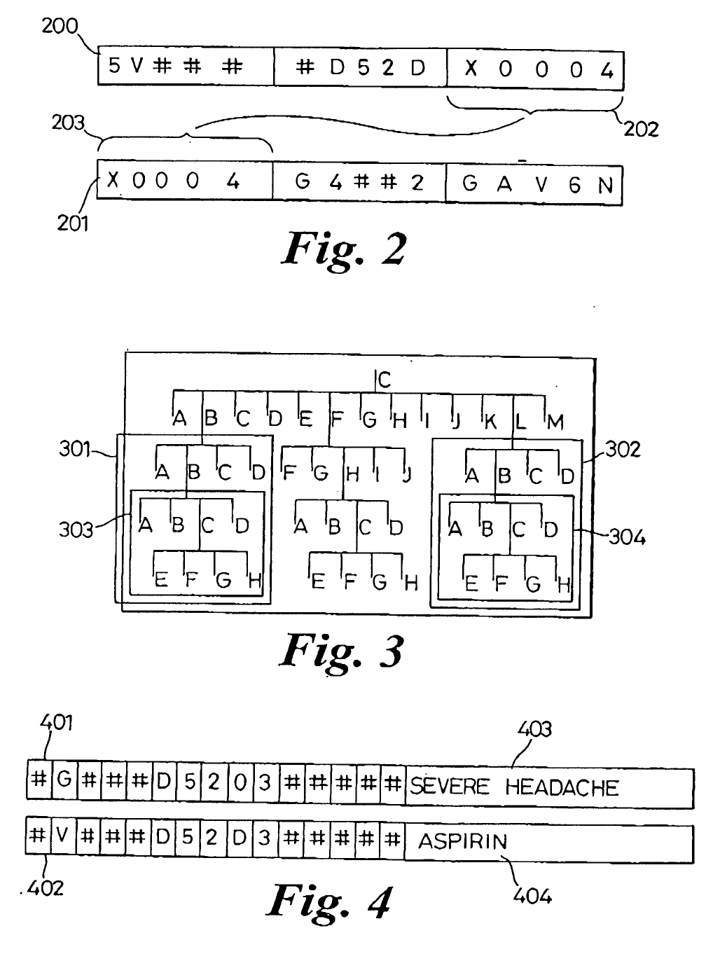

FIG. 2 shows a root expression and extension expression in accordance; with those used in the present invention,

FIG. 3 shows a symbolic portion of a data model useful in explaining aspects of the present invention;

FIG. 4 shows a pair of expressions to illustrate context switch links therebetween;

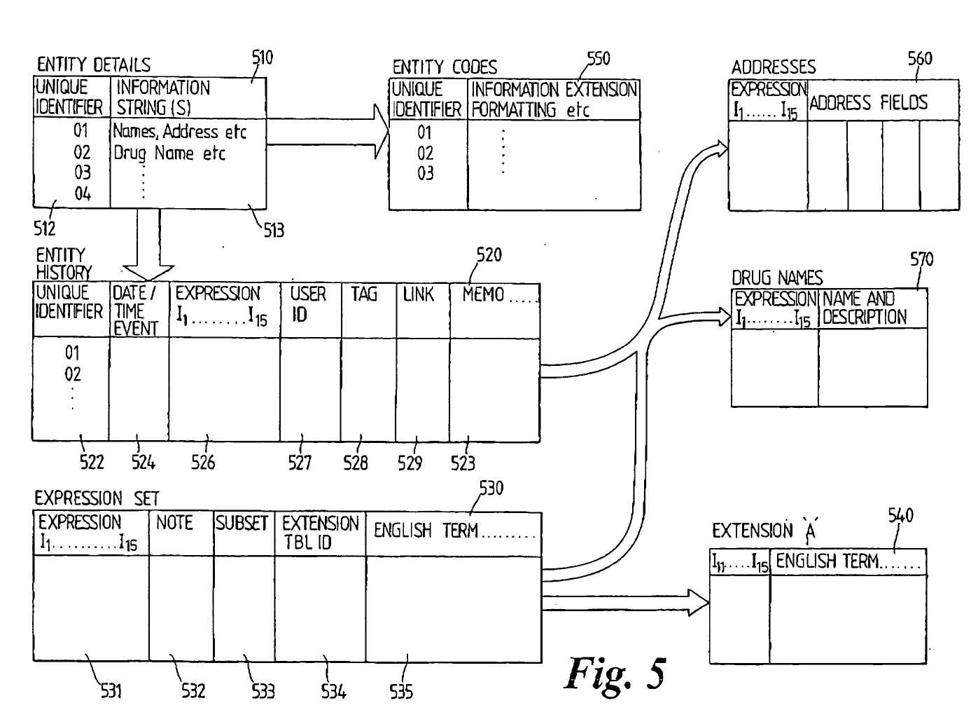

FIG. 5 shows a plurality of table structures and their inter-relationship which can be used in the implementation of the present invention;

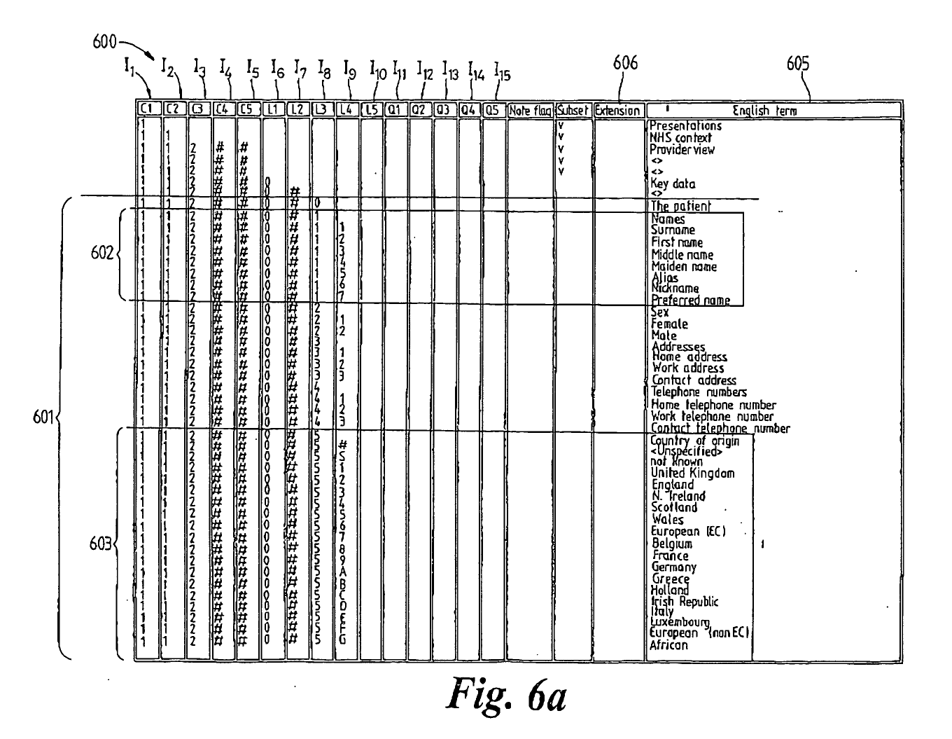

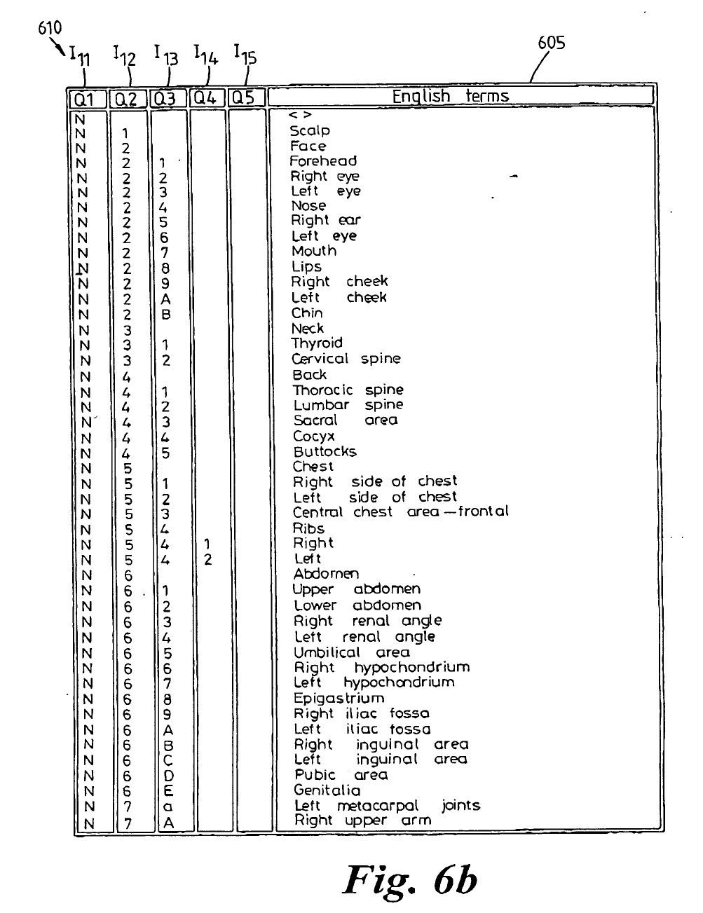

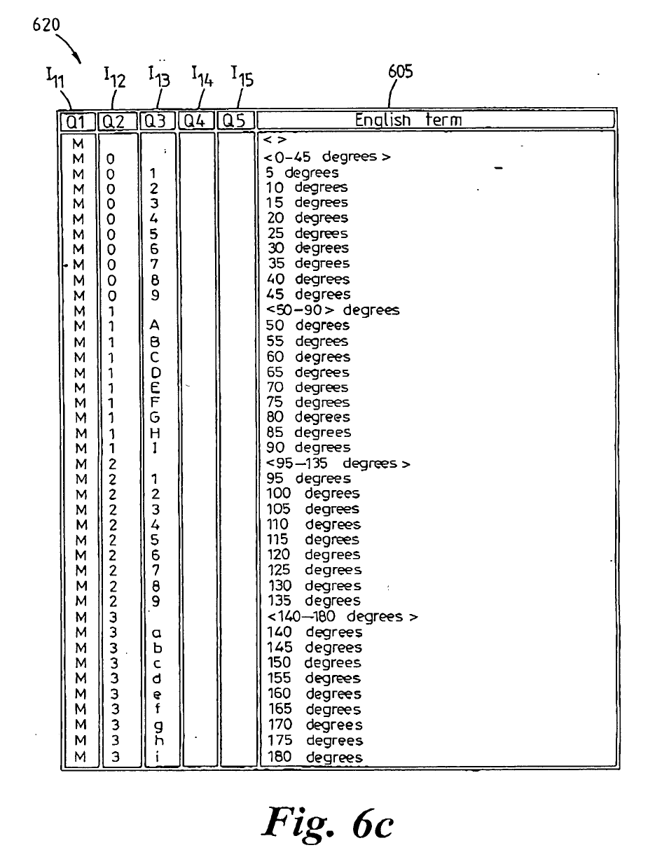

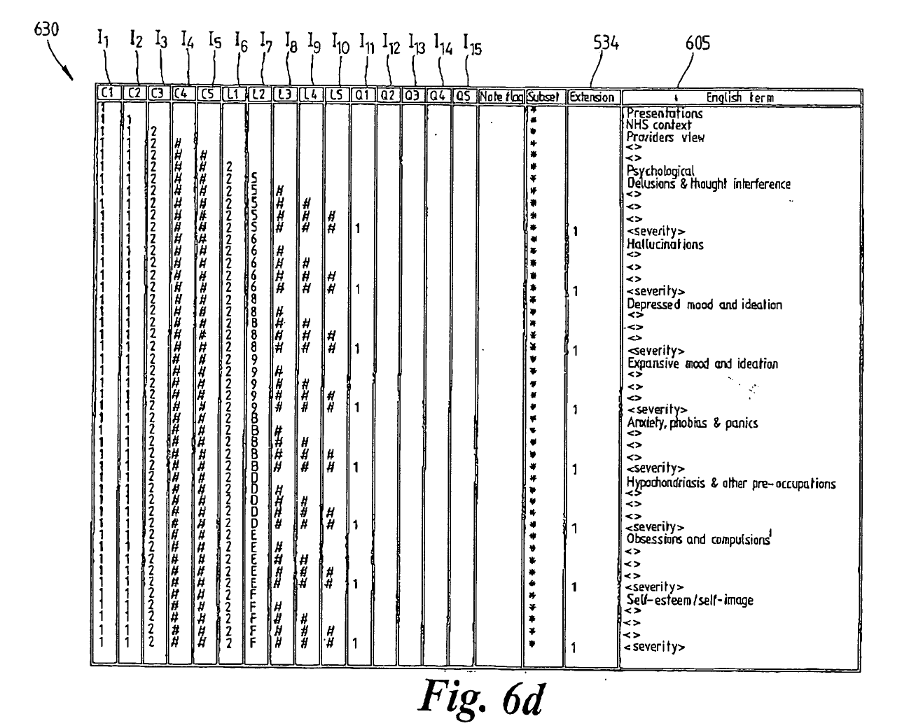

FIGS. 6a to 6d show portions of exemplary expression set tables;

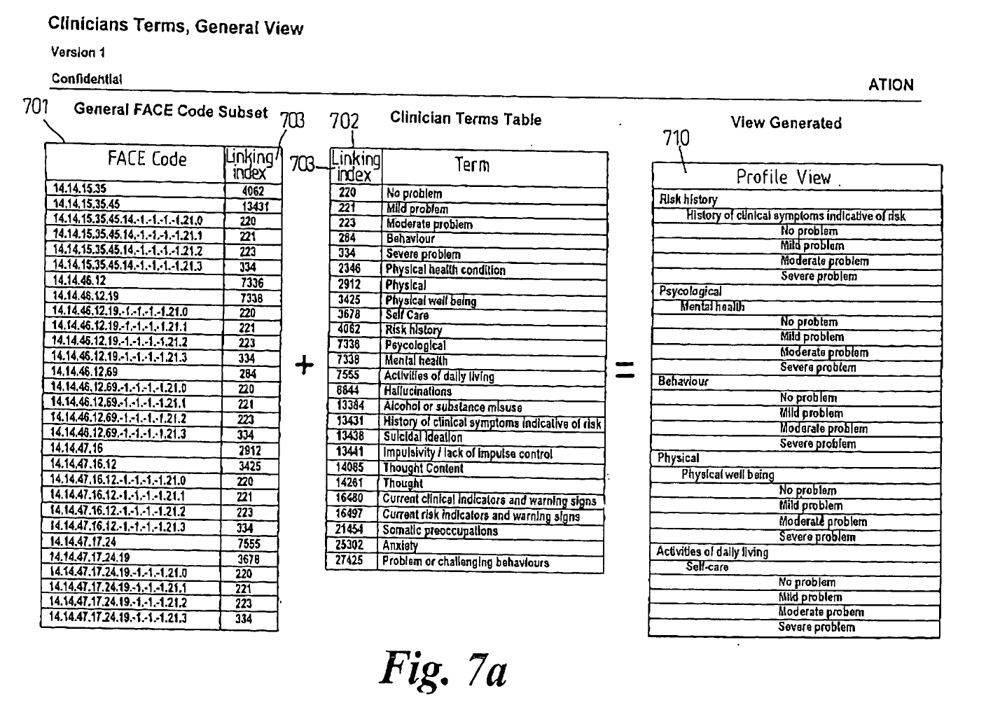

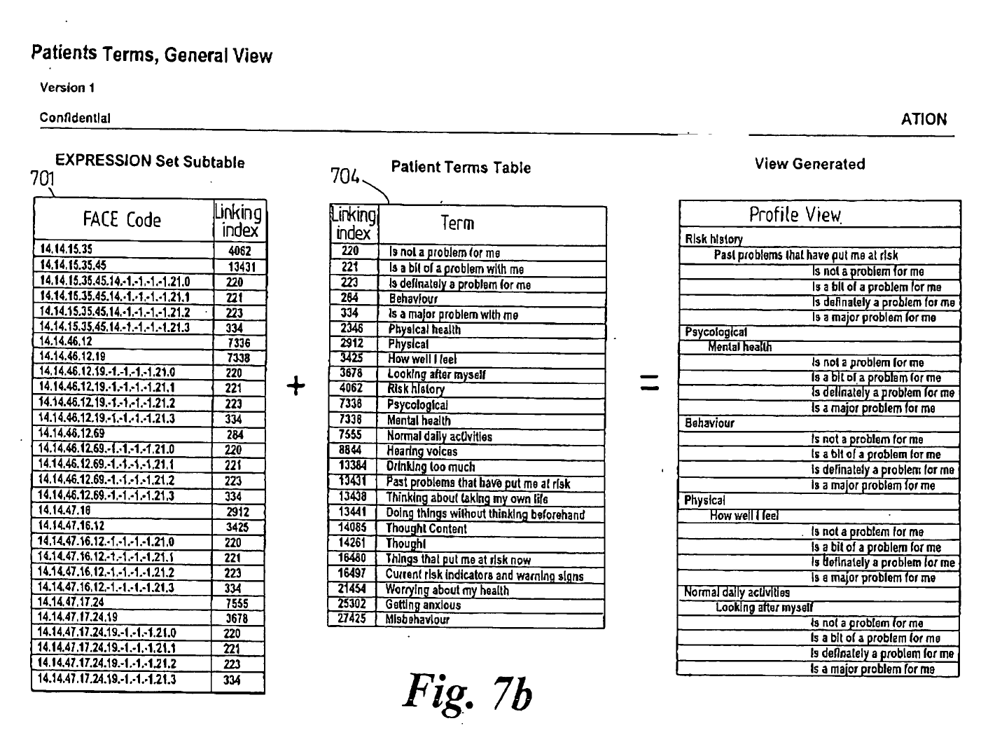

FIG. 7 shows corresponding portions of an expression set table or sub-tables showing differing data definitions relating to different classes of user;

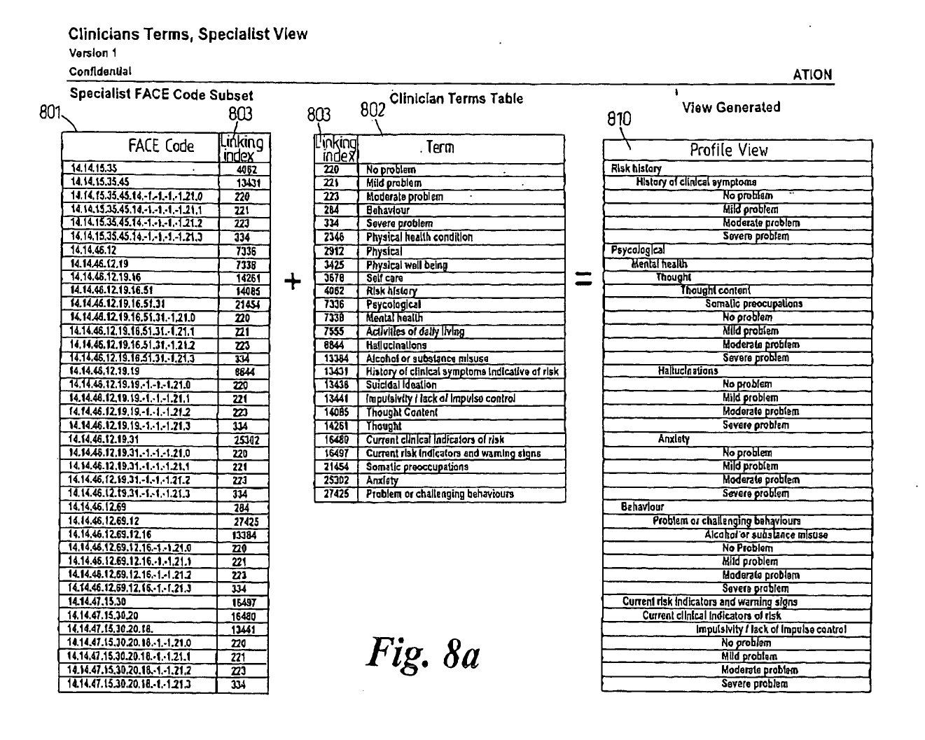

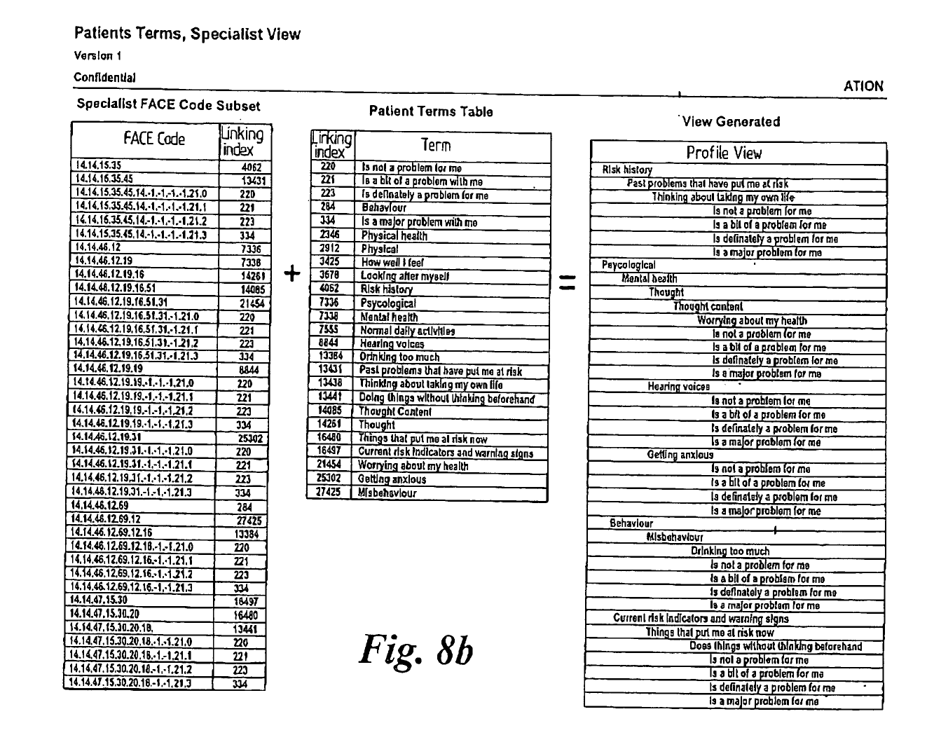

FIG. 8 shows corresponding portions of an expression set table or sub-tables, in which data definitions relating to different classes of user do not have a one-to-one correspondence;

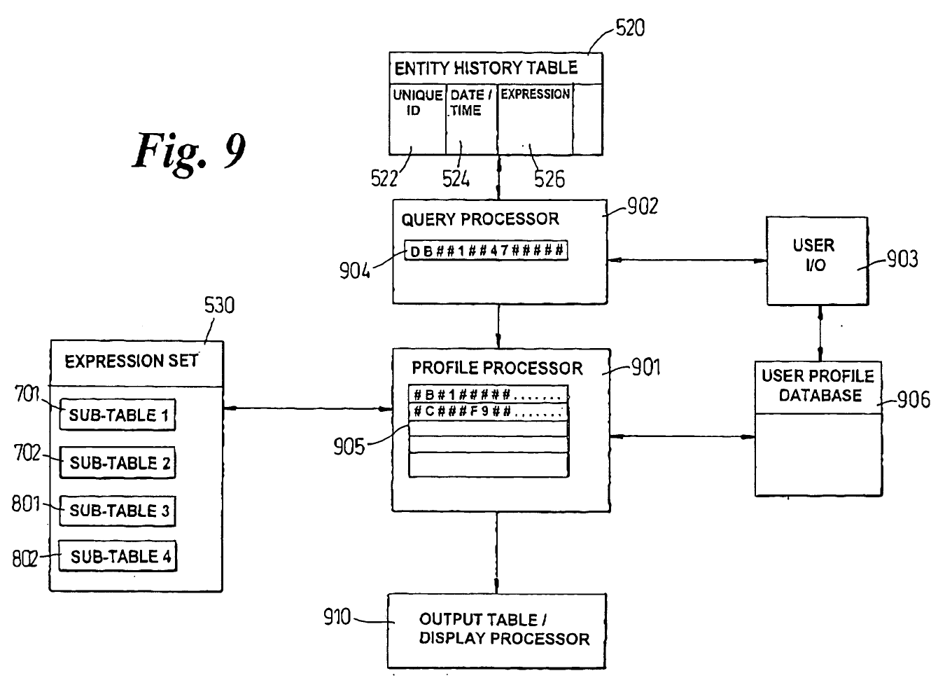

FIG. 9 shows a profile processor according to one aspect of the present invention; and

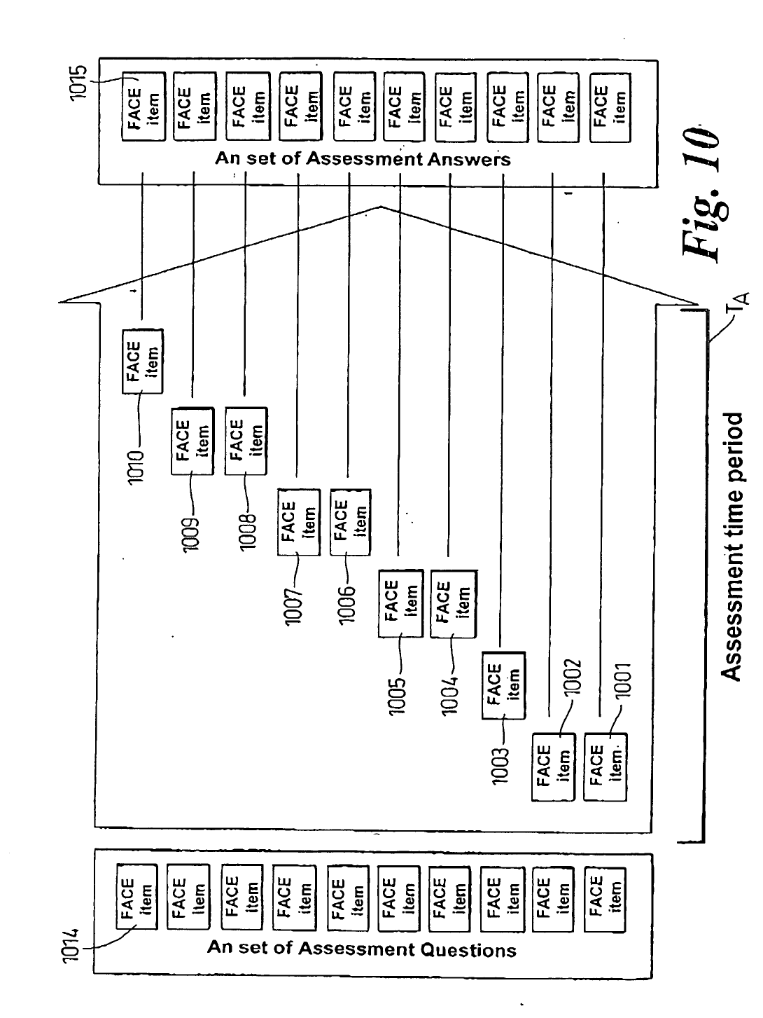

FIGS. 10 to 12 show graphically, events that may be recorded in an entity history table and the chronology thereof.

### THE DATA MODEL

In the present invention, the physical model, ie. the storage model which represents the physical structure of the data stored on the computer system is designed to be much closer to a conceptual model of the real world, ie. the data model of the organisation(s) using the database. This closeness is normally difficult to achieve, simply because the requirements of the computer-accessed disks and other storage media are so different from the human view of the organisational structure being represented by the database. A database implementation which can simplify the interface between the physical model and the conceptual model offers huge advantages in terms of the speed of processing when accessing information from the database, and also greatly simplifies the software and hardware interface necessary to achieve this interface.

In one embodiment, every entity, every attribute and every occurrence of every entity in the data model is uniquely specified by a multi-character “expression” which may conveniently (for the sake of clarity of explanation) be divided into a number of “words”. As illustrated hereinafter, the “expression” may comprise three five-byte words, with each byte representing one ASCII character selected from a set of approximately 200. The number of “words”, however, is not critical to the invention and merely imposes a convenient semantic structure to the expressions as they relate to the data model.

It will be understood that the number of bytes representing a character in the expression, or the length of the overall expression, can be varied according to the requirements of a particular system. In a presently preferred embodiment, the multi-character expression is formed from twenty two-byte characters or “elements”, so that each element may represent any one of 65536 possible different characters.

The expressions do more than simply provide a unique label to each entity, each attribute and each occurrence of each entity, but also implicitly encode the data model by reference to its hierarchical structure and protocol. This is achieved by use of the strict hierarchical protocol in the assignment of expressions to each entity. This can be achieved automatically by the database management system when the user is initially setting up the database, or preferably is imposed by a higher authority to enable the database structure to conform to wider standards thereby ensuring compatibility with other users of similar database systems.

The way in which the database structure is imposed by the assignment of these expressions is best described with reference to an exemplary data model as shown in FIG. 1.

The tree structure in FIG. 1 represents the “known universe” of the data model. Each hierarchical level of the data model is shown horizontally across the tree structure, and each one of these hierarchical levels may be represented by an appropriate byte I₁ to I₁₅ of the expression shown vertically on the left hand side of the drawing. At the highest level of the tree I₁, we have context information defining the organisation using the data, for example the National Health Service, Prison Service, Local Authority, Educational Establishment etc.

The significance of byte I₂ will be discussed later, but broadly speaking indicates a data type from a plurality of possible data types that might be used. Within each organisation (eg. the Health Service) there may typically be a number of departments or functions or data view types (represented by byte I₃) such as administration, finance/accounts and clinical staff, all of whom have different data requirements. These different data requirements encompass:
a) different data structures or models reflecting different organisational hierarchies within the department;
b) different views of the same entities and occurrences of entities; and
c) the same or different views of “standard format” data relating to different occurrences of similar or identical entities or attributes.

The significance of this to the present invention will become clear as one progresses downward through the hierarchy.

Each department may wish to segregate activities (eg. for the purpose of data collection and analysis) to various regional parts of the organisation: eg. a geographically administered area or a sub-department. This can be reflected by expression byte I₄. Each geographically administered area may further be characterized by a number of individual unit types, such as: (i) hospitals, health centres etc. in the case of an NHS application; (ii) schools or higher education institutions in the case of an education application; (iii) prisons and remand centres in the case of the prison service application.

Each of the organisations and units above will have different data structure requirements (as in (a) above) reflecting different entities, attributes and entity relationships within the organisation and these are provided for by suitable allocation of codes within the I₆ to I₁₀ range of expression bytes. In this case, the same alphanumeric codes in bytes I₆ to I₁₀ will have different meaning when in a branch of the tree under NHS than when under, eg. the education branch, even though they exist at the same hierarchical level. As an example, the sub-tree structure represented by particular values of bytes I₆ to I₁₀ may refer to patient treatment records in the NHS context, whereas those values of codes may refer to pupil academic records in the education context.

However, in the case of (b) above, where the organisational unit requires the same or different views of the same entities, attributes and occurrences of entities as other organisational units, the codes in bytes I₆ to I₁₀ of one branch of the tree will represent the same underlying structure and have the same meaning as corresponding byte values under another branch of the tree. An example of this is where both the administration departments and the finance departments require a view of the personal details of the staff in the hospital, both doctors and nurses. Note that the views of the data may be the same or different for each department, because the view specification is inferred from the higher level I₁ to I₅ fields. In this case, as will be explained later, for entities, attributes and occurrences of entities which are the same in each sub-branch, some or all of the codes I₁₁ to I₁₅ which identify each entity occurrence will have identical values.

In the case of (c) above, ie. the same or different views of standard format data relating to different occurrences of similar or identical entities and their attributes, it will be understood that a number of predefined bytes require the same specification regardless of the particular organisation using them. For example, a sub-tree relating to personnel records, and including a standard format data structure for recording personnel names, addresses, National Insurance numbers, sex, date of birth, nationality etc. can be replicated for each branch of the tree in which it is required. For example, all of the organisations in the tree will probably require such an employee data sub-tree, and thus by use of standardised codes in bytes I₆ to I₁₀ such organisational sub-trees are effectively copied into different parts of the tree. However, in this case, the context information in fields I₁ to I₅ will indicate that within each organisation, we are actually dealing with different occurrences of similar format data.

The tree structure defined by the expressions I₁ to I₁₅ can be used to define not only all entity types, all entity attribute types and all entity occurrences, but can also be used to encode the actual attribute values of each entity occurrence where such values are limited to a discrete number of possible values. For example, in the subtree relating to treatments in the NHS hospital context, “drug” is an entity which has a relation with or is an attribute of, for example: doctors (from the point of view of treatments prescribed); patients (from the point of view of treatments given); administration (from the point of view of maintaining stocks of drugs) and so on. The entire set of drugs used can be provided for with an expression to identify each drug. In an illustrative embodiment, the parts of the expression specific to the occurrences of each drug will be located in the I₁₁ to I₁₅ fields as shown in FIG. 1. Thus when used in conjunction with the appropriate fields I₁ to I₁₀, it will be apparent whether the specified drug is in the context of a treatment prescribed by a doctor, a treatment received by a patient, or a stock to be held in the hospital pharmacy.

Further bytes in the expression, lower in the hierarchy can be associated with the drug to describe, for example, quantities or standard prescription types. It will be apparent whether the expression refers to a prescribed quantity or a stock quantity by reference to the context information found higher in the hierarchy. In practice, the number of discrete values allowed for each of these grouped “entity values” using the five fields I₁₁ to I₁₅ is approximately 200⁵=3.2×10¹¹. As will be described later, the number of permutations allowed can actually be expanded indefinitely, but in practice this has not been found to be necessary. It is noted, however, that the described model of FIG. 1 merely illustrates a principle of the data model. In a presently preferred embodiment, twenty-character expressions are used and the semantic significance of specific fields therein (I₁ to I₂₀) may differ significantly from those presently described in connection with FIG. 1. For example, in a presently preferred model, “entity values” now occupy each of the two-byte elements I₁₃ to I₂₀, thereby allowing 65536⁸ discrete values (=3.4×10³⁸).

Thus, in the fifteen character expression I₁ to I₁₅, each character represents a natural language expression (eg. English language expression) defining some aspect of the data model, and by travelling downward through the table it is possible to compose a collection of natural language expressions which represents the complete specification of an entity, an attribute or an entity occurrence.

Implementation

For the following detailed description of an implementation of the present invention, we shall use the following data modelling scheme, although it will be understood that the method of the present invention applies to a wide variety of data model designs. In this data model, all information may be regarded as being about either a “presentation”, or an “activity”. A presentation is some thing or notion which is presented to the user. An activity is some thing or notion which is initiated by the user.

However, in further embodiments, other classifications of information may be specified as desired. This does not affect the operating principles of the database. For example, in a presently preferred arrangement, a third category of information—“diagnosis”—has been implemented, in the use of the invention in a medical context. In one context of medical use, the expression set has been adapted to conform to existing internationally recognised professional standards for description of mental diseases, ICD 10. In another context, the expression set has been adapted to conform to a standard diagnosis set called DSM IV from the American Psychiatric Association.

For example, the tree structure of FIG. 1 is, largely, a presentation to the user about the hierarchical structure of the organisation in which the user is working, and the lists of patients, doctors, nurses, school pupils and prisoners are all presentations of things in existence and their relationship with that data structure.

Activities may be regarded as events which the user records or initiates which affect the database—ie. treating a patient, updating a person's records, ordering further supplies of drugs etc. An activity is often initiated in response to a presentation—that is to say, the doctor may view the relevant records of the database presented to him in the form of patient treatments, and prescribe further treatment based thereon.

Information about presentations and activities can only be recorded when associated with an object. In other words, the “patient treatment” per se has only abstract meaning until it is linked with a particular patient, doctor, hospital etc.

The exemplary database structure will be described with reference to five activities which take place in the creation and maintenance of the database.

“Registration” we describe as the recording of static information about an object's existence, which is all presentation information. The registration process itself can, however, be regarded as an activity. This process is embodied in the steps of constructing the tree structure of FIG. 1, and recording information about each entity at the “bottom” layer of the tree: ie. identifying drug no. 1 as “aspirin”.

“Profiling” we describe as recording information about the object's condition, which information is likely to change, and may therefore be regarded as dynamic. The distinction between static and dynamic information is not a rigid one: static information can also be subject to change, and dynamic information might not actually change. An example of dynamic information might be the assignation of a patient to a certain doctor for a certain type of treatment. Compare this with static information represented by the recording of the existence of the patient in the data model by giving the patient a unique identifying number. Loosely speaking, the registration of static information is the identification of each entity occurrence at the bottom of the tree structure of FIG. 1 (eg. DrugNol, DrugNo2, . . . DoctorID1, DoctorID2, . . . PatientID1, PatientID2 . . . ) and the profiling activity corresponds to defining an entity occurrence's (PatientID1) relationship with the tree (eg. associating the patient with HospitalNo1 or DoctorID1).

“Response”, or “planned response”, is regarded as recording information about responses to an object's condition—ie. updating patient records with treatment details etc.

“Event logging” is regarded as recording information about a sequence of events associated with responses to an object's condition. This is activity and presentation information. For example, it is necessary to ensure that the history of a patient within the hospital can be tracked over a period of time, with details of all treatments and referrals indicated.

“Reporting” allows the user of the database to query the system to extract specified information therefrom.

To carry out all of these activities, a database engine uses the expression set introduced above. As previously discussed in general terms, a full expression consists of, in a presently described embodiment, fifteen elements, divided into three groups of five elements, also known as words. The first word, I₁ to I₅, is reserved for context specification, ie. whose view the expression reflects, the sense of the expression and the domain of the expression. We shall call this the context word. The second word, I₆ to I₁₀, is reserved for specifying a particular procedure, entity or event in the context specified by the context word. We shall call this the specification word. The third word, I₁₀ to I₁₅, is reserved for specifying qualitative information regarding the procedure, entity or event. We shall call this the qualitative word.

Thus, in addition to defining the upper layers of the tree structure shown in and described with reference to FIG. 1, the context word can also specify the sense of the data identified by the expression. For example, there may be codes embedded into the context word which indicate that we are dealing with presentation information, activity information, or response information, etc. In the illustrated embodiment of FIG. 1, this “sense of the data” is indicated by the value of byte I₂.

The expression can thus be a complete description of a situation: a place, an associated event and a frequency of occurrence; or perhaps a person, an associated action and some measure of quality of that action.

This is in contrast to other coding systems which are usually of an atomic nature. In atomic coding systems, a particular code will describe a particular feature, action or state. To fully describe a situation, then, an arbitrary number of codes must be grouped together in some way. For example, one code for a place, another for an event, perhaps another to complete the event description and then a qualifier of some sort. There is nothing in the codes to indicate the relationship these codes have with one another.

The expressions used in accordance with the present invention have a grammar. Each expression indicates a context, a specification and a quality. If any of these components are unknown or irrelevant, then by default, the expression indicates that this is so by the use of “wild card” characters (which we shall generally refer to as non-deterministic characters).

We also note, at this stage, that although the embodiment described here uses an expression which is fifteen characters in length, to represent a tree structure that is fifteen layers deep, different length expressions or even extension trees are possible. The expression may include a unique code in the third word bytes I₁₁ to I₁₅ which indicates that the word represents a pointer to a further expression. For example, with reference to FIG. 2 there is shown an exemplary extension expression. Root expression 200 contains the three five-character words, with the final five characters representing the link to extension expression 201. The third word 202 includes a special designated character (shown as “X”) in position I₁₁ which indicates that the following four characters in bytes I₁₂ to I₁₅ represent a pointer label to the extension expression 201. The pointer label is replicated in the first word 203 of the extension expression. Thus the presence of the “X” in byte I₁ identifies the status of the expression as an extension expression. In the extension expression, the characters in bytes I₆ to I₁₅ represent a further sub-tree appended to the main tree of FIG. 1. It will be understood that extension expressions may be used to greatly increase the number of entity occurrences, attributes or ranges of possible values of attributes over that which is provided by the root expressions.

A blank element in an expression is used to indicate that there is no further detail in an expression. Thus every element to the right of a blank element must also be blank. This can be understood by recognising that a branch of the tree in FIG. 1 cannot exist unless it is connected to the root via branches hierarchically above it.

Where there is no specification at any position in the expression, this is indicated by the wild card symbol “#”.

A feature of the use of expressions to describe the data model is that similar data structures, or sub-trees, are replicated throughout the main tree by using similar expression patterns. For example, with reference to FIG. 3, sub-trees 301, 302 have the same structure, and sub-trees 303, 304 have the same structure.

There are three paths down through the hierarchical tree of FIG. 3. With traditional hierarchical browsing systems, the user would explore their way down the tree to the extremities. This is also the case with the present invention. However, the use of the expression sets also provides the ability to jump to other similar places in the expression set. This can be done in all hierarchical systems by back-tracking until a branch is reached where an alternative route is decided upon. Then the user would explore this new route until the required branch is reached. With reference to FIG. 3, at least six steps are required to get from path CBBCF to CLBCF. Each step presents the opportunity of making a wrong decision that would delay the finding of the correct data. The use of expressions allows one step jumping from sub-tree 301, or 303 to sub-tree 302, or 304 which would otherwise need many back and forward tracking steps to be made.

This is achieved by the positional integrity, or the “place value” of the characters within the expressions. It can be seen that by changing the B in the second position to an L, the correct expression is arrived at. The lower level elements remain the same which, through the rules of positional integrity, means that the detail description is identical but we may now be talking about a member of staff in the NHS or a member of staff in the prison service.

A further application of this feature is that the data model can be arranged to permit data type context changes to be made by changing perhaps only one higher order digit in the expression. For example, the high order character I₂ is chosen to represent the context of the data model—eg. “presentation” or “response”, then, as shown in FIG. 4 for example, whilst diagnosing a particular disorder at a detailed level, by changing the value of one high order element in the specification word, the user can be left in perhaps the response region of expression codes for this particular disorder. In the example of FIG. 4, this is illustrated by changing the second order element in the context word from “G” to “V”.

An overview of the use of an expression set together with the implementing tables which comprise an illustrative embodiment of the database system of the present invention is now described with reference to FIG. 5.

Every occurrence of an entity about which information must be stored is recorded in the entity details table 510. Each occurrence of each entity is given a unique identifier 512 which is assigned to that entity occurrence, and information about the entity is stored as a value expression information string 513. Examples of value expressions are the character strings giving names, street addresses, town, county, country etc, or drug name, manufacturer's product code etc. These details are essentially alphanumeric strings which themselves contain no further useful hierarchical information and are treated solely as character strings. As will become apparent later, the decision as to which occurrence values are handled at this level is determined by the user's requirements. For example, an address may be recorded entirely as character strings having no further hierarchical significance. Alternatively, the county or city field, or postcode portion of an address might usefully be encoded into an expression in order that rapid searching and sorting of, for example, geographical distribution of patients becomes possible.

Entering this information may be regarded as a registration activity, in that static information about an object's existence is being recorded in the database.

Attributes which may only take permitted discrete values from a set of possible values may be effectively recorded in the expression I₁ to I₁₅ associated therewith as will be described later.

The unique identifier 512 of each entity occurrence in the entity details table 510 provides a link to an entity history table 520 where entry of, or update to the entity occurrence status is stored. In this table, the event updating the database is given a date and/or time 524, an expression 526, and the unique identifier 522 to which the record pertains, and may include other information such as the user ID 527 of the person making the change.

This activity is “profiling”: in other words recording information about the entity and its relationship with the data model. An example of this is assigning to PatientID1 (from the entity details table 510) an attribute value, HospitalNo1 by use of the appropriate byte I₅ in the expression.

In the entity history table 520, various details of the event being recorded may not be available, or may have no relevance at that time. For example, a new patient in a designated hospital may be admitted, and some details put on record, but the patient is not assigned to any particular doctor or ward until a later time. Additionally, some information may be recorded which is completely independent of the user view or other context information. Thus the event is logged with only relevant bytes of the expression encoded. Bytes for which the information is not known, or which are irrelevant to the event are non-deterministic and are filled with the wild card character, “#”.

The entity history table 520 may also include an event tag field 528 which can be used in conjunction with a corresponding field in an episode management table to be described hereinafter. It will indicate which coding activity was being carried out when the expression was assigned to the entity. For example, this tag could indicate whether the coding was carried out during an initial assessment, an update, a correction, a re-assessment, etc. This tag also orders entity codes into event groups. For example, in the medical context, when a person enters the system as a patient, they initiate an episode. An episode can have many spells, and a spell can consist of many events. What is more, a patient can be undergoing more than one episode at a time, and under each episode, more than one spell at a time. Many organisations need to store this sort of information for costing and auditing purposes. By coding this information into an expression, it will be possible to browse this information.

The entity history table may also include a link field 529 which is designated to link related groups of codes allocated during a particular entity-event-times. For example, in a social services application, a home visit, a visit date, miles travelled and the visitor could all have an expression associated with the visit event. The link field will link these expressions together. Alternatively, the event tag field may also cater for this function.

A memo field 523 may also be included in the entity history table to allow the user to enter a free text memorandum of any length for each code allocated to an entity. In effect, every time a field is filled, a memo can be added.

The expression set of the entire database is recorded in a third table, the expression set table 530. This encodes each expression against its natural language rmeaning, and effectively records the data model as defined by the hierarchical structure of FIG. 1. There is a natural language meaning for each byte of the expression, each byte representing a node position in the data model tree, and the precise significance of every occurrence of every entity or attribute is provided by concatenating all natural language meanings for each byte of the expression: eg. NHS—Presentation Data Type—Administrator's View—Region1—HospitalNo2—Doctor Record—Name—DoctorID1.

As has been discussed previously, the expressions may include expression extenisions which map a sub-tree onto the main tree For convenience, these extension expressions can be located within the expression set table 530 (the extension entries being identified by the byte I₁, or could be located in a supplementary table (not shown), in which the pointer fields I₁₁ to I₁₅ of the main expression are used as the first fields I₁₁ to I₁₅ of the extension expression.

The entity history table 520 and the expression set table 530 may each include an extra field holding a version code. In the entity history table, this would indicate a version number of the expression in use at the time the record was created; in the expression set table, expressions may be varied over time according to the version code given. This allows the structure of the hierarchy to change over time without necessarily introducing new expressions. This assists in maintaining backward compatibility of recorded data.

Further details of the tables and their structures will be discussed hereinafter. In use, the database management system first constructs the data model tree structure in the expression set table 530, with each expression being allocated a corresponding natural language term. This can be done by dialogue with the user, or by systems analysis by an expert. Preferably, the use of pre-formatted codes representing certain data strictures are used by many different users. For example, personnel file type structures may be used by many different organisations. This allows compatibility of databases to allow data sharing between organisations, with users being allocated blocks of codes for their own user-specific purposes, as well as using shared codes which have already been defined by a higher authority.

In FIG. 6a, an exemplary expression set table portion 600 representing a personal details sub-tree is shown. It will be observed that fields I₈ and I₉ represent the personal detail sub-tree data structure which can be replicated for any part of the tree. That is to say, the sub-tree 601 can represent attributes of a patient (as shown) or in a different part of the tree may represent attributes of a prisoner, or member of staff. Note that the “names” grouping 602 (I₈=“1”) provides a sub-tree of entity attributes, eg. “surname”, “first name” etc., each of which will have a number of entity occurrences associated therewith, each having specific values. Each occurrence will be separately identified using the lower order fields of the expression (not shown). The actual values will be installed as character strings in the entity details table 510 (see FIG. 5). By contrast, the country of,origin entity 603 (I₈=“5”) provides a sub-tree of discrete entity attribute values: eg. “England”, “Scotland”, “Wales”, “Belgium”, “France” etc. Thus, in this case, the tree structure (ie. the expression itself) can provide the individual attribute values of the entity “Country of Origin”.

In FIG. 6b, a further exemplary expression set table portion indicates a sub-tree relating to diagnoses on a patient. Only the expression values I₁₁ to I₁₅ are shown for brevity. This expression sub-set provides a sub-tree of possible attribute values relating to diagnoses or operations etc. As mentioned above, these attribute values for diagnoses might correspond to industry or professional standard classifications such as ICD 10 or DSM IV.

In FIG. 6c we show an expression set table portion representing a sub-tree which can be used to provide a “standard” range of discrete attribute values relating to angles between 0 and 180 degrees. In FIG. 6d we show an expression set table portion 630 representing categories of medical presentations.

In other contexts of use, these expression subsets can cover qualifier types such as “weight”, “length”, “colour”, “temperature” etc, each with possible respective scales of uses, such as human weights in kg, car travel distances in miles, colour in Pantine code, temperature in K scale, respectively.

FIGS. 6a-6c demonstrate a further possible embodiment of the database implemnentation of the present invention. In FIG. 6a it is noted that bytes I₁₁ to I₁₅ are not shown. In practice, there can be some advantages in operation in constructing separate tables to contain discrete “chunks” of the expression set table 530, that is chunks relating to adjacent groups of I₁₁ to I₁₅ codes which all relate to the same I₁ to I₁₀ value. These each form an extension table 540 which is pointed to by an extension table pointer located in column 606 of the expression set table 600. This is particularly useful where repeating chunks of I₁₁ to I₁₅ codes are found in many places throughout the expression set table 530. Thus sub-tables 610, 620, 630 could be tables in their own right, not forming part of the main table, and can thus be used at numerous locations down the main table 530.

According to a preferred embodiment of the present invention, the use of separate sub-tables such as those in FIGS. 6b and 6c enables different user views of the same basic data to be readily accommodated.

For example, with reference to FIGS. 7a and 7b, different users may require different views of the same or similar data. In FIG. 7a, an expression set table (or table portion 701, as shown) lists relevant fields of an expression set table 530 corresponding to fields I₁₁ to I₁₅. In this example, however, the expression set uses a number of numeric codes rather than the single character alphanumeric codes represented in FIGS. 6a to 6d. In addition, the numeric code “−1” is used instead of the wild card character “#”. The corresponding natural language terms 535 are now found in a clinician's terms table 702 linked to the expression set table 701 by a linking index 703 common to each table The clinician's terms table 702 provides a series of corresponding natural language terms, or more generally, data definitions, as applicable to and understood by a clinician.

In FIG. 7b, the same expression set table portion 701 with linking index 703 is now shown together with corresponding natural language terms 535 in a patient's terms table 704 which provides a series of corresponding natural language terms as might be applicable to, and understood by a patient.

It will be understood that the natural language terms table 702 or 704 that is relevant in any particular situation, can be determined according to one or more higher level fields I₁ to I₁₀ (not shown) in the expression. As will also be explained later, the determination of which sub-table is relevant may also, or alternatively, be determined with reference to a user identity.

When taken in combination with natural language expressions deriving from the higher level fields I₁ to I₁₀ (not illustrated in FIG. 7a or FIG. 7b), a context of use provides the full “profile view” as indicated by the headings and sub-headings in table 710.

The illustrations of FIGS. 7a and 7b relate to what is described as a general view, ie. natural language expressions are provided to a predetermined degree of contextual specialisation. More specialist views are illustrated in FIGS. 8a and 8b where a more detailed contextual level is provided. For example, the psychological health context in FIGS. 7a and 7b is broken down further into mental health and behaviour categories only. In FIGS. 8a and 8b, the clinician's views and the patient's views of psychological health context are sub-divided into much more detailed categories as shown in table 810 (mental health—thought—thought content—somatic preoccupations; hallucinations; anxiety; behaviour etc). This additional contextual information is provided by virtue of a greater degree of resolution in the expression sets in table 801. Here it will be noted that many expression set fields that were previously non-deterministic (“−1”) are now specified precisely, thereby providing the higher degree of contextual specification.

It will be understood that corresponding clinician and patient view terms tables 702 and 704, 802, 804 need not have a one-to-one correspondence between corresponding data definitions. For example, where one user view requires a different level of granularity of information content, broader qualitative or quantitative data definitions may be found in the table 704 than in the table 702.

In FIGS. 6a-6d, the expression set table uses a standard notation. Because of the hierarchical nature of the expressions, it is essential to maintain positional integrity. Thus, with reference to FIG. 6a, the patient sub-tree must commence at level I₈ of the tree structure, regardless of the complexity of the tree structure above. Thus, if there is only one organisation using the database, or if there a limited number of user views required, there may be no requirement to use some higher order context specifiers (eg. I₄ and I₅). These unused fields have no specification at that point and are represented by “#”. Where there is no specification this is represented in the natural language term field 605 by the symbols “<>”. It will be understood that these particular choices of special characters are entirely arbitrary. In practice, each “character” of the expression set may be encoded by a two-byte binary word, for which specific values may hold special meaning.

In constructing the table, for implementational reasons discussed later, it is highly desirable that the table is maintained in strict alphanumeric order of expressions, with discontinuities between higher and lower tree branches filled in with blank specification lines (ie. those represented by “<>”). It will be understood that these correspond to particular levels within the tree structure for which there are no divisions of branches.

Additional fields may be included in the expression set table. For example, a note flag field 532 may be used to signify that explanatory information is available for a term. This would typically provide a pointer to a notes table. A symbol in this field could indicate the existence of, for example, passive notes (information available on request); advisory notes (displayed when the code is used); and selection notes (displayed to the user instead of the natural language term) A sub-set field 533 may also be provided for expression maintenance tasks, but these are not discussed further here.

When an expression set table has been constructed, it can be related to individual entity occurrences in the following manner. As previously discussed, the unique occurrences of entities can be placed in the entity details table 510, each having a unique identifier 512. This is linked to the expression set table, and thus to the tree via the entity history table. This records the entity unique identifier 512 in a column 522 and links this with the appropriate expression or part expression 526. The date of the event is logged in field 524, and other details may be provided—eg., whether the data entry is a first registration of a record, whether it is a response record (eg. updating the database) etc.

Other tables may be used beyond those described in connection with FIG. 5, or the tables structured differently. In one embodiment, the expression set in table 530 is used to identify entities and attributes of entities, together with individual occurrences of entities that do not change over time. Details of occurrences of entities that are transient to the data model may be recorded in a separate table, such as the entity history table 520. Such transient objects may be, for example, individual personnel whose existence in the data model is impermanent or whose function (place) within the data model may change over time (eg. by promotion of staff or transfer within the organisation). In this instance, the unique identifier 522 and date/time field 524 relative to the expression field 526 indicate the function of that entity occurrence at that time.

The entity ID table 550 (FIG. 5) is an example of a secondary table which is used when communicating and sharing data with other systems. This table matches the entity unique identifier ID codes with entity ID codes used by other systems.

It is also possible to record static entity details in a form which is structured ready for input and output For example, name, address and telephone records may be stored in successive columns of an address table 560, each record cross-referenced to the main data structure by the expression code or cross-referenced to an entity by the expression code I₁ to I₁₅. The link can thus be made with either the expression set table 530 or the entity history table 520. Then, whenever that branch of the tree is accessed pertaining to one individual record, the full static and demographic details of that entity occurrence may be accessed from a single table.

A similar arrangement is shown for providing detailed drug information, by drug table 570.

A further modification may be made to the embodiments described above in respect of the use of the entity details table 510. It is not essential for all information about an entity occurrence to reside in the entity details table 510. In some models, it is advantageous to restrict the use of the entity details table 510 to that of a “major entity” only—the most significant entity forming part of the modelled organisation. For example, in the hospital environment, the patient could be chosen as the major entity. In this case, all other (non-structural, character-string) information about entities can be located in an appropriate field of either the entity history table 520, or the expression set table 530. In the case of the entity history table 520, an appropriate field to use is the memo field 523, and in the case of the expression set table 530, an appropriate field to use is the natural language term field 535. It will thus be understood that, where the non-structural information held about even the major entity is small, the entity details table 510 can be dispensed with all together.

Reporting

The present invention offers significant advantages in the execution of reporting and database querying functions particularly for multiple users or multiple classes of users.

To answer a given query, the database system defines a query expression comprising fifteen bytes which correspond with the expressions as stored in the entity history table 520 and expression set table 530. The query expression will include a number of deterministic bytes and a number of non-deterministic bytes. The non-deterministic bytes are effectively defined as the wild-card character “#”—“matches anything”. The deterministic bytes are defined by the query parameters.

For example, a simple query might be: “How many patients are presently registered at hospital X.” To answer this query, the query expression imposes deterministic characters in fields I₁ (=NHS), I₄ (=hospital identity), I₆ (=patients). Other context information may be imposed by placing deterministic characters in bytes I₂ (=presentation information). All other bytes are non-deterministic and are set to “#”. The database scans through the expression set table matching the deterministic characters and ignoring others. Note that in the preferred embodiment, the expression set table is maintained in strict alphanumeric sequence and thus very rapid homing in on the correct portions of the database table is provided where high-order bytes are specified. This will normally be the case, since the hierarchical nature of the expression set will be arranged to reflect the needs of the organisation using it. The database system can then readily identify all the tuples of the expression set table providing a match to the query expression.

A significant advantage of the database structure will now become evident. The answer to the initial query has effectively homed in on one or more discrete portions of the expression set table and counted the number of tuples matching the query expression. Supposing that the user now requires to “progressively browse” by stipulating additional conditions: “How many of those patients are being prescribed drug Y” requires only the substitution of the non-deterministic character “#” with the appropriate character in the requisite field Iₙ of the expression to change the result. Similarly, carrying out statistical analysis of other parameters, such as: “How many patients were treated by doctor Z with drug Y” can rapidly be assessed. It will be understood that progressively narrowing the query will eventually result in all bytes of the query expression becoming deterministic and yielding no match, or yielding a single patient entity match whose details can then be determined by reference to the entity details table 510 (or the appropriate memo field).

The key to the speed of result of the statistical querying function is the construction of the expression set table. When imposing conditions on various attributes of an entity, ie. by setting a deterministic character in a byte of the query expression, the relevant data will be found in portions of the table in blocks corresponding to that character. Progressive sub-querying requires only scanning portions of the table already identified by the previously query. Even where a higher level context switch takes place, relevant parts of the expression set table can be accessed rapidly as they appear in blocks which are sequenced by the expression hierarchy.

Scanning the table can be achieved most efficiently by recognising that only the highest order, deterministic byte of the query expression need be compared with corresponding bytes of each record in the expression set table until a first match is obtained. Thereafer, the next highest order byte must be included, and so on until all deterministic bytes are compared. This results from maintaining a strict alphanumeric ordering to the table.

A second type of querying relates to examining the historical aspects of the database. For example, the query may be, “In the last year, what drugs and quantities have been prescribed by doctor X?” To answer this query, the query expression is formulated in the same manner as before, imposing deterministic bytes in the appropriate places in the query expression. This will include one or more “lowest order” bytes in I₁₁ to I₁₅ which actually identify a doctor, and non-deterministic characters against the drug fields. This time, however, the entity history table 520 is scanned, in similar manner, seeking only matches of deterministic characters. In a preferred embodiment, the entity history table will be maintained in chronological sequence and thus the search can be limited to a portion of the table where date limitations are known and relevant. Matches of deterministic characters will be found throughout the table where a relevant event relating to prescription of a drug by doctor X is found. Note that the entity history table may include other fields which can be used to impose conditions on the query, such as the user ID of the person entering the record.

A third type of querying relates to analysis of the records pertaining to a single entity value: the entire medical record of patient X. In the preferred embodiment, patient X would be identifiable from the entity details table 510. The query would initially involve searching for the patient's name to locate the unique identifier (unless that was already known). Once the unique identifier for a patient was known, then the entire entity history table can be scanned very rapidly for any entry including the unique identifier. The strengths of the present invention will then be realized in that the output from this scan will provide a number of entries each of which carries all of the relevant information about that patient incorporated into the extracted expression bytes I₁ to I₁₅. The entire patient's record can then be “progressively browsed” without recourse to any further searching operation on the main entity history table. Specific details of the patient's treatments, doctors, hospital admissions, prescriptions etc are all very rapidly available at will be assertion of appropriate deterministic bytes in the expression I₁ to I₁₅.

It is noted that the event history table will include many records where the expression stored in the record contains many non-deterministic bytes. For example, where a doctor X prescribes a patient Y with drug Z, other bytes of the expression may be either not known, or not relevant. For example, the patient may have been assigned to a ward W in the hospital which could be identified by another byte. However, this venue in which the treatment took place might be: a) unknown; b) known but not relevant to the record; or c) automatically inferrable from the context of the person making the record entry. Whether this information is included in the record is stipulated by the users; however, it will be noted that it does not affect the result of the query whether the byte in the entity history table relating to WARD W is deterministic or non-deterministic, because the query expression will set that relevant byte to non-deterministic unless it is stipulated as part of the query.

When the database system has extracted all of the records of the entity history table matching the query expression, it preferably saves these to a results table for further querying, or progressive browsing. For example, the results table can then be analysed to identify which treatments were made at an individual hospital, or by an individual doctor by setting additional conditions on particular bytes of the query expression. Memo fields can be extracted to view comments made at the time of treatment. It can be seen that the results table formed in response to the initial query actually contains all of the information relevant to a given patient's treatment, and not just the answer to the initial query “What drugs have been prescribed to patient X?”

In summary, the information of the database is stored in such a manner that data for a query may be extracted far more rapidly than relational database storage schemas, and with an expression for each extracted record. The presence of this expression in the query result has an important effect. A unique reporting benefit gained is the scope for progressive browsing and “interactive reporting”. When a database query is executed to provide information for a report, the answer will be made up of a number of expression records. This subset of expressions inherits all the structural information held in the main expression set.

As a general example: a detailed report on the number of severe hallucination instances in a given geographical area during the past year might return a subset of 12,000 expressions. Because these are fill expressions, higher and lower level information is also inherent in this subset. Further investigation of the answer through browsing the returned hierarchy might reveal that 70% of cases were male, or 30% of cases occurred in the prison service, etc. Similarly, a high level report on the number of instances of hallucination in a particular organisation might return a subset of 9,000. More detailed information will be inherent in this retrieved subset. By progressive browsing of this subset, it may transpire that 90% of mild occurrences were in planning departments or that 5% of severe occurrences were in education departments. The processing time required to browse this information with further, more detailed, “sub-queries” is substantially speeded up over prior art systems simply because the expression set readily provides all the lower level information.

With reference to FIG. 9, there is described a profile processor that particularly facilitates the input and output of queries and data according to specific requirements of a variety of users. The profile processor is adapted to allow different views or profiles of the data stored in the database according to the individual user, or class of user. The profile processor is particularly suited in its specific functionality for hardware implementation using programmable electronic gate circuitry (eg. uncommitted logic arrays or ASICs) and dedicated volatile and non-volatile memory.

In the present invention, it has been recognised that the expression I₁ to I₁₅ encoded in the expression set table 530 and in the entity history table 520 can be used not only for matching against a query expression comprising a selection of deterministic and non-deterministic characters, but also for deploying a set of profile expressions, also each comprising a selection of deterministic and non-deterministic characters, that can be used to control the output and display of search results according to the individual user.

The profile processor 901 effectively acts as a filtration stage in conjunction with a query processor 902. A user input 903 provides a query expression 904 comprising a selection of deterministic characters and non-deterministic characters “#”. As previously explained, records will be extracted from the entity history table 520 by the query processor 902 whenever a match of every deterministic character in the query expression 904 matches a corresponding deterministic character in the expression field 526 of the entity history table 520. Extracted records will be passed through to the profile processor stage 901. The profile processor 901 obtains a series of user profile expressions 905 from a user profiles database 906, according to the identity of a user logged into the system, or according to the class of user logged into the system. Each of these user profile expressions 905 comprises a set of deterministic characters and non-deterministic characters. The user profile expressions define deterministic fields of the expressions extracted by the query processor that must match the extracted records in order to allow the record to be passed through to the display. In the preferred embodiment, the set of user profile expressions 906 filter the extracted records on a Boolean OR basis, ie. for each extracted record there must be a match with at least one of the user profile expressions. It will be understood, however, that an alternative record filtration basis would be to filter the extracted records on a Boolean AND NOT basis, ie. for each extracted record, there must be no deterministic character matches with any user profile expression. In this case, the user profile expressions would define areas of the database to be excluded.

The user profile database 906 may also provide an indication of which expression set table 530 and/or sub-tables 610, 620 should be used for a specific user profile to generate the data description or natural language term corresponding to the extracted record. For example, within the expression set table 530, or linked thereto, a plurality of distinct sub-tables 701, 702 or 801, 802 (as described with reference to FIGS. 7 and 8) may be provided. Each sub-table may be specific to a particular user or group of users. As the profile processor 901 filters the extracted records retrieved from the entity history table by the query processor, the expression 526 from any records that match both the query expression 904 and the user profiles 905 is used to extract the data description or natural language term from expression set table according to the sub-table 701, 702, 801, 802 that is prescribed by the user profile provided by user profile database 906.

In use, the database system would be established to give each user a profile in the user profile database. The user profile would include the set of profile expressions 905 used to filter data retrieved by the query processor. The user profile would also include a set of sub-table pointers each pointer corresponding to one expression in the expression set table 530, that will indicate which sub-table 701, 702, 801, 802 should be used when matching the retrieved expression. The user profile database can also be used to specify the layout and structure of display presented to any particular user or class of users.

As an illustration, there may be five general classes of views. A “discipline view” may be provided for each user discipline, such as “nurse”, “doctor”, “hospital administrator”, etc. These views will filter for different sets of data, according to the requirements of the discipline. Similarly, a “specialist view” may be provided for each sub-group of the disciplines, eg. the class “doctor” may have optional specialist views of “cardiac specialist”, “ENT specialist” etc in which different levels of detail of information are filtered by the profile processor. Another class of view, the “perspective view”, may present the same essential information, but use a different sub-table 610, 620 to provide the natural language terms—a perspective view for separate groups of persons, such as “doctor” and “patient” can be provide so that each class of person can see the data presented in a comprehensible format.

Note that although the illustrative embodiment shows the query processor as the first record extraction stage from entity history table, and the profile processor as the second stage, it will be understood that these two operations could be reversed, although this would be very much less efficient.

The query processor 902 may also be provided with capability for generating “event views”, in which the records are filtered according to date/time stamps in the entity history table. Similarly, “key views” comprising specific predetermined information (data types) regarding one entity occurrence (eg. a specific patient) may be provided. In these “key views”, the specific data types selected for view may be chosen on the basis of fixed data types for a given type of entity, eg. certain categories of biophysical data for a patient). Alternatively, the data types selected for display may be variable based upon data values for a given entity. For example, the key view for any patient may be based upon those data types for which a data value is stored that holds data values that are scored above a predetermined critical value, or outside a predetermined critical range. This provides each entity occurrence with its own “key view” of a few items of importance, eg. key problems. In reporting, it becomes possible to select a patient and then very quickly extract for display the total population of entities that share those key problems so as to generate a real time empirical normative view against which to compare the single patient.

In the latter instance, the profile processor 901 may call upon user profile expressions 906 that identify specific quantitative data values indicated by the expression, eg. where an expression in the entity history table 520 indicates that a patient has a value of blood pressure that is above recommended limits.

It will understood that the entity history table 520 represents a log of events recorded over time against a plurality of entities, entity occurrences or attributes thereof. Each event could relate, for example, to a specific assessment, diagnosis or treatment event of a patient in a hospital. The particular type of event (eg. diagnosis of a specific condition; measurement of a quantitative physiological parameter such as blood pressure, heart rate, etc; qualitative assessment of particular condition in the patient; or application of specific treatment) is indicated according to the particular expression 526 logged in the table. The quantitative or qualitative value ascribed to the event may be entered as an information string eg. in table portion 523, or may be encoded in the expression 526 itself, as explained above.

With reference to FIG. 10, it will be seen that an entity history relating to, say one patient or collection of patients, may comprise a series of assessment events or items 1001 . . . 1010 which may be spread over a time period T_{A}. Each assessment item may be an answer, or response 1015, to an assessment question 1014. Thus, each item 1001 . . . 1010 within the time period T_{A} should generally be retrieved from the database when seeking to extract patient information for a particular assessment or treatment episode. This can readily be achieved in the present invention by setting the deterministic characters of the query expression 904 to those that correspond to the patient and assessment or treatment episode while leaving as non-deterministic those characters that relate to the individual items or events within the treatment episode. The data can readily be limited to the time period T_{A} simply by scanning only the small portion of the entity history table 520 covering that time period. It will be recalled that the entity history table is preferably maintained in chronological sequence.

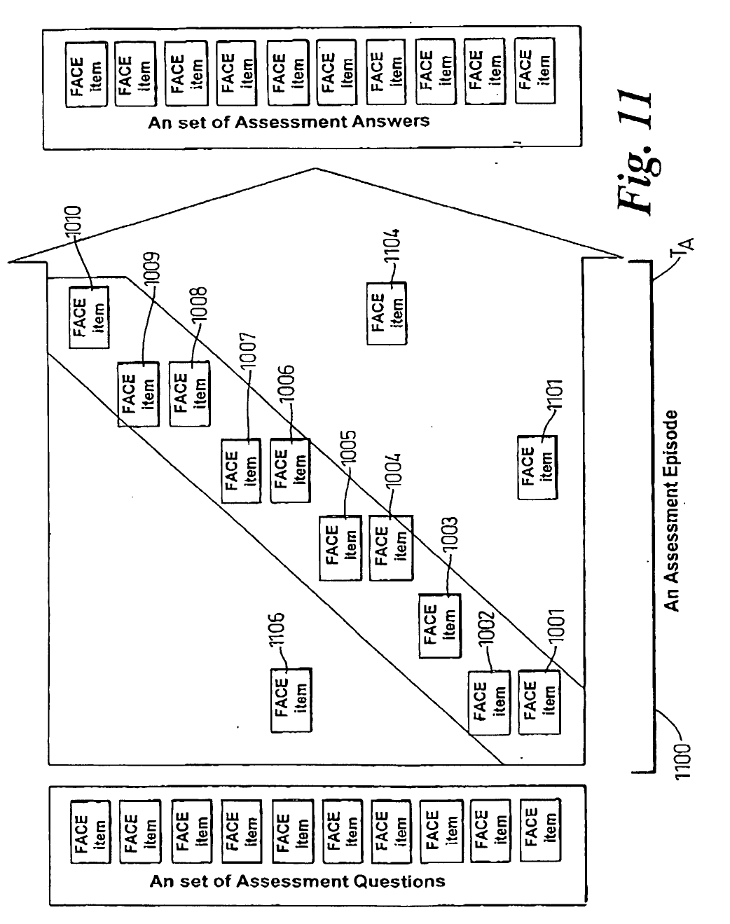

More generally, however, and with reference to FIG. 11, certain assessment items (eg. 1001, 1004, 1006) may have multiple responses (eg. 1101, 1104, 1106) where data are gathered or tests carried out more than once. It will be clear that in any true appraisal of the data relating to a given assessment episode 1100, records over the time period T_{A} should be taken into account, conventionally by a statistical process such as averaging. The output processor 910 preferably handles this process.

The structure of the data records in the database of the present invention enables very rapid data extraction over a predetermined time window, since event records in the entity history table are in chronological sequence. Still further, the time window over which records are extracted from the entity history table can also be specified not as a pair of time limits between which records should be extracted (eg. “Tₘᵢₙ<T_{extract}<Tₘₐₓ”), but as a band around a specified target time (“T±Δ”), referred to as a “width of now”. This essentially defines the granularity of the data extraction required.

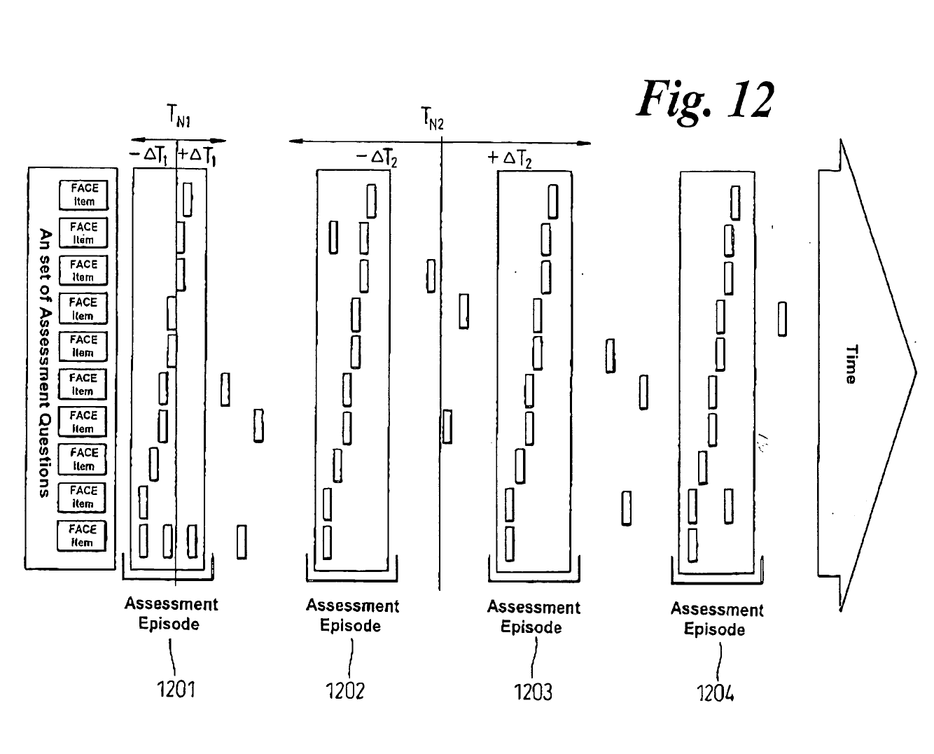

With reference to FIG. 12, the effect of providing an ability to specify ΔT at will on data extraction is readily apparent. Specifying a target time T_{N1} and “width of now” value ΔT₁ ensures that all the data from the relevant assessment episode 1201 is captured. Similarly, specifying a target time T_{N2} and “width of now” value ΔT₂ ensures that all the data from two adjacent assessment episodes are captured. By simply doubling or tripling the value of ΔT₂, data from all four episodes 1201 . . . 1204 would be captured. Such a change in ΔT value in real time during querying would have a very minor effect on data extraction time, since the query expression 904 remains unaltered and the contiguous portion of the entity history table 520 being scanned is merely expanded slightly.

Thus, a user of the database may quickly re-specify ΔT during a query session to review the effects on average data, almost in real time.

Still further, ΔT may be automatically specified (or provided with a default value) according to the query expression 904. In other words, there may be provided a series of default values for ΔT for different types of records that automatically ensure that data is extracted to an appropriate degree of granularity. ΔT values might be inferred from both the query expression or possibly from the user profile.

It will be understood that while the example given relates to extracting data in respect of perhaps a single patient, a user gathering general data for a treatment plan over many patients (eg. several hospitals) need only modify the query expression 904 to change a deterministic character representing a specific entity occurrence to a non-deterministic character covering all entity occurrences for that particular treatment plan.

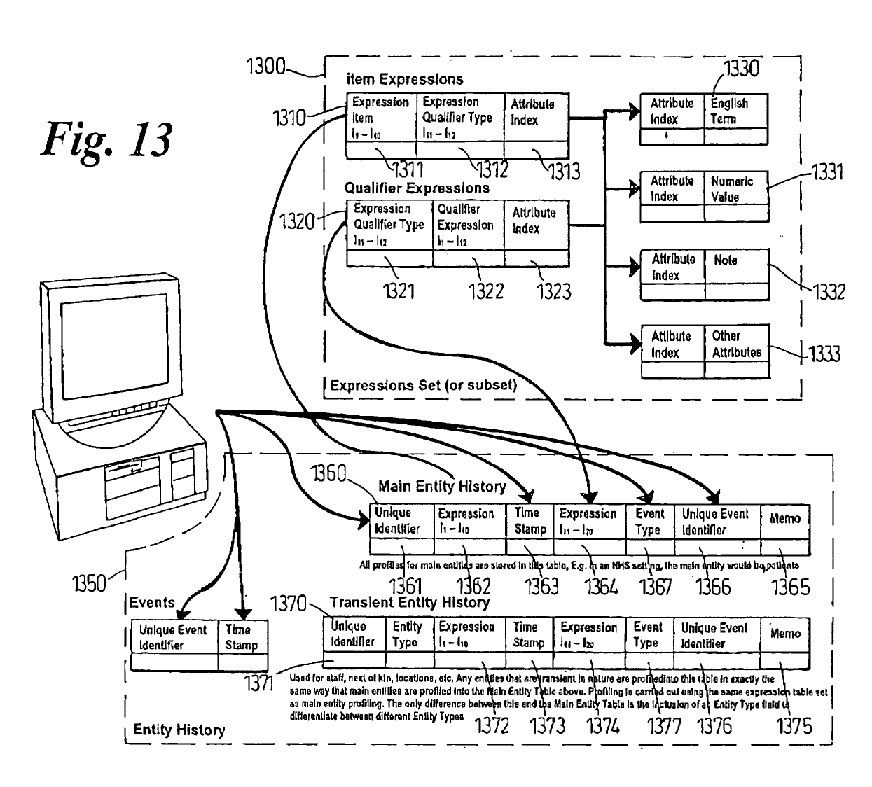

With reference to FIG. 13, an alternative table structure for the expression set table 530, 540 and entity history table 520 of FIG. 5 is shown. In this embodiment, the expression set table 1300 is divided into an item expression portion 1310 providing: in columnn 1311 the main part I₁ to I₁₀ of the expression broadly relating to hierarchical position of the entity in the data model; in column 1312 the expression qualifier data type indication characters I₁₁, I₁₂ (indicating, eg. that the entry relates to a measurement of length) and in column 1313, an index to a series of tables 1330 to 1360 providing information relating to that expression, such as the natural language term, numeric value, freeform notes or links to other attributes.

The entity history table 1350 is also divided into a “main” entity history table 1360 and a “transient” entity history table 1370. The main entity history table 136 is used for profiles of entities that are key to the context of the organisation being represented, and are also generally speaking permanent entities. In a health service context, these “main” entities would be patients. The “transient” entity history table 1370 carries the histories of other entities within the organisation, eg. staff, next of kin, locations, facilities etc. Each entity history table 1360, 1370 comprises a unique identifier field 1361, 1371; a expression field 1362+1364, 1372+1374; an event date/time field 1363, 1373 and a memo field 1365, 1375, in common with the embodiment description in connection with FIG. 5. However, in this presently preferred embodiment, the tables also include an event identifier field 1366, 1376 which records either an item instance or a qualifier instance. This is to distinguish between independent or successive events that relate to an attribute item or qualifier.

In practice, events which occur relating to an attribute of an item can be events that occur in parallel or in series. For example, an entity history table entry may indicate that at time T1 the attribute “colour” of entity1 was “RED”. At a later time, the entity history table may record that at time T2, the attribute “colour” of entity1 was “BLUE”. Either:
(i) the entity1 has two colours (scenario 1), or
(ii) the entity1 colour has changed over time (scenario 2), or
(iii) the entity1 actually comprises two discrete items (scenario 3).

These different scenarios are recorded by distinguishing in the event identifier field 1366, 1376 the two entity history events as
(i) instance1, time1, item1 and instance1, time2, item1 (scenario 1), or
(ii) instance1 time1, item1 and instance2, time2, item1 (scenario 2), or
(iii) instance1, time 1, item1 and instance2, time2, item2 (scenario 3).

Also included in the event history tables 1360, 1370 is an event type field 1367, 1377 that may be used for rapid retrieval of all similar events (eg. assessments, diagnoses, care records, registrations etc.

The present invention can be readily realized both in software, and in hardware. It will be understood that the database querying essentially requires rapid fifteen byte wide comparison of the expressions I₁ to I₁₅. An extremely fast co-processor ASIC could thus be manufactured which includes up to fifteen eight-bit comparators in parallel. In practice, querying would never require all fifteen bytes to be compared, as most queries involve the setting of a large number of the bytes to a non-deterministic state, thus in practice requiring fewer parallel circuits and enabling simplification of the design of a dedicated co-processor.

1. A method of operating a database system comprising the steps of:
assigning to each of a plurality of entities, attributes and entity occurrences, a unique, multi-character expression, the expression having a predetermined hierarchical structure which defines the relationship between each entity, attribute and entity occurrence;
storing said expressions in an expression set table linking each element of each expression with a data definition relating the expression to a hierarchical level and a position in a data model;
recording events in an entity history table, each event having associated therewith a relevant expression from the expression set table;
extracting records from the database according to a multi-character query expression comprising characters which are deterministic to the query and characters which are not deterministic to the query;
filtering the extracted records according to a plurality of multi-character profile expressions each comprising characters that are deterministic and characters that are non-deterministic and which together define filtration criteria;
outputting only extracted records that meet the filtration criteria and match the query expression.

2. The method of claim 1 wherein the extracting step comprises:
scanning at least a selected portion of the entity history table to examine the expression contained in each record;
matching every deterministic character of the query expression with every deterministic character in the examined record; and
where each deterministic character of the query expression matches the respective record expression, extracting the record.

3. The method of claim 1 wherein the filtering step comprises:
matching every deterministic character of each profile expression with every deterministic character in the extracted record and discarding said record unless each deterministic character of the extracted record matches each deterministic character of at least one profile expression.

4. The method of claim 1 further comprising the step of maintaining a user profile database storing, for each of a plurality of users or classes of user of the database system, a respective set of said multi-character profile expressions.

5. The method of claim 4 further comprising the steps of:
storing a plurality of corresponding data definitions for each of a plurality of said multi-character expressions in said expression set table; and
maintaining, in said user profile database, for each of said plurality of users or classes of user, an indication of which of said data definitions are to be associated with each multi-character expression.

6. The method of claim 5 wherein said plurality of corresponding data definitions are maintained in a plurality of sub-tables linked to the expression set table, and wherein the user profile database identifies at least one sub-table for each user or class of user.

7. The method of any one of claims 4 to 6 further comprising the step of maintaining, in said user profile database, for each of a plurality of users or classes of user, an output format for controlling the display of said outputted, extracted records.

8. A method of operating a database system comprising the steps of:
assigning to each of a plurality of entities, attributes and entity occurrences, a unique, multi-character expression, the expression having a predetermined hierarchical structure which defines the relationship between each entity, attribute and entity occurrence;
storing said expressions in an expression set table linking each element of each expression with a data definition relating the expression to a hierarchical level and a position in a data model;
recording events in an entity history table, each event having associated therewith a relevant expression from the expression set table;
extracting records from the database according to a Boolean combination of (i) a multi-character query expression comprising characters which are deterministic to the query and characters which are not deterministic to the query and (ii) a plurality of multi-character profile expressions each profile expression comprising characters that are deterministic to predetermined filtration criteria and characters that are non-deterministic to predetermined filtration criteria, by selecting records in which every deterministic character of the Boolean combination matches a corresponding deterministic character in said expressions in the database; and
outputting said extracted records.

9. Database apparatus comprising:
means for storing, for each of a plurality of entities, attributes and entity occurrences a unique, multi-character expression, the expression having a predetermined hierarchical structure which defines the relationship between each entity, attribute and entity occurrence;
means for storing said expressions in an expression set table linking each element of each expression with a data definition relating the expression to a hierarchical level and a position in a data model;
means for storing, in an entity history table, a plurality of recorded events, each event having associated therewith a relevant expression from the expression set table;
a query processor for extracting records from the database according to a multi-character query expression comprising characters that are deterministic to the query and characters that are not deterministic to the query;
a profile processor for filtering the extracted records according to a plurality of multi-character profile expressions each comprising characters that are deterministic and characters that are non-deterministic and which together define filtration criteria; and
output means for generating an output of all extracted records that match the filtration criteria.

10. A method of operating a database system comprising the steps of:
assigning to each of a plurality of entities, attributes and entity occurrences, a unique, multi-character expression, the expression having a predetermined hierarchical structure which defines the relationship between each entity, attribute and entity occurrence;
storing said expressions in an expression set table linking each element of each expression with a data definition relating the expression to a hierarchical level and a position in a data model;
recording events in an entity history table, each event having an event time and a relevant expression from the expression set table associated therewith; and
extracting records from the entity history table according to a multi-character query expression comprising characters that are deterministic to the query and characters that are not deterministic to the query, and according to a predetermined time window function.

11. The method of claim 10 wherein the predetermined time window function is a function of the multi-character query expression.

12. The method of claim 10 or claim 11 wherein the predetermined time window function is retrieved from a user profile database.

13. The method of claim 10 wherein said extracting step includes the steps of:
receiving, from a user, said multi-character query expression and a specified time value or range of values for said record extraction; and
determining a time band value for expanding said specified time value or range to automatically capture records a predetermined distance outside said specified time value or range of values.

14. The method of claim 13 further including the step of aggregating the captured records according to a predetermined statistical process.

15. Database apparatus comprising:
means for storing, for each of a plurality of entities, attributes and entity occurrences, a unique, multi-character expression, the expression having a predetermined hierarchical structure which defines the relationship between each entity, attribute and entity occurrence;
means for storing said expressions in an expression set table linking each element of each expression with a data definition relating the expression to a hierarchical level and a position in a data model;
means for recording events in an entity history table, each event having an event time and a relevant expression from the expression set table associated therewith; and
means for extracting records form the entity history table according to a multi-character query expression comprising characters that are deterministic to the query and characters that are not deterministic to the query, and according to a predetermined time window function.
